(19) United States
(12) Patent Application Publication
(10) Pub. No.: US 2019/0318369 A1
(43) Pub. Date: Oct. 17, 2019

(54) METHOD AND DEVICE FOR PREDICTING BUSINESS VOLUME

(71) Applicant: KOUBEI HOLDING LIMITED, George Town (KY)

(72) Inventors: CHAOFENG MENG, GEORGE TOWN (KY); CHI FAN, GEORGE TOWN (KY); HAN LUO, GEORGE TOWN (KY); YIHUAN SUI, GEORGE TOWN (KY); FANGYU DOU, GEORGE TOWN (KY)

(73) Assignee: KOUBEI HOLDING LIMITED, George Town (KY)

(21) Appl. No.: 16/469,894

(22) PCT Filed: Dec. 13, 2017
(86) PCT No.: PCT/CN2017/115767

§ 371 Date: Jun. 14, 2019

(30) Foreign Application Priority Data
Dec. 15, 2016 (CN) 201611158664.6

(51) Int. Cl. G06Q 30/02

(52) U.S. Cl. CPC G06Q 30/0202; G06Q 50/12; G06Q 30/0205

(57) ABSTRACT

Disclosed are a method and a device for predicting business volume. The method includes: determining a prediction time and a historical time corresponding to the prediction time; acquiring historical payment data for a business provider; determining a number of historical payments for the business provider at the historical time on the basis of the historical payment data; and predicting business volume of the business provider at the prediction time on the basis of the number of historical payments.

### CROSS REFERENCE TO RELATED APPLICATIONS

This application is a national stage application of International Application No. PCT/CN2017/0115767 filed on Dec. 13, 2017 which is based upon and claims priority to Chinese Patent Application No. 201611158664.6, titled “METHOD AND DEVICE FOR PREDICTING BUSINESS VOLUME”, filed with the Chinese State Intellectual Property Office on Dec. 15, 2016.

### TECHNICAL FIELD

The present disclosure relates to the technical field of the internet, and particularly to a method and a device for predicting business volume.

### BACKGROUND

Business volume is one of the important indicators that reflect a business situation. For example, regarding a business that provides on-site services, such as restaurants where on-site dining is the main business, cinemas, supermarkets, entertainment facilities, the business volume can largely reflect the business situation of a store. In general, the activity of the business activities increases and the liveness of the consumption environment increases with the increase in business volume. Users often want to acquire the business volume of the store, such as historical business volume and future business volume, to provide a reference for their own consumption behavior.

Regarding future business volume, the user may want to acquire a time or a time period when business volume of a store is large, because the user may wish to experience a lively consumption environment and atmosphere. As another example, other users may want to acquire a time or a time period when business volume of the store is small, so that they may choose the time or time period to go to the store, so as to reduce a waiting time or get a better on-site service. Regardless of the situation, an important factor for improving user experience is to provide future prediction information to the user as accurately as possible.

However, only historical data is provided to the user in related art, such as the business volume of the store each day of last week or the business volume per time period (for example, hourly) of yesterday. Therefore, demands of the users for future information have not been met yet.

Therefore, a method and a device for predicting business volume are required in the field, to provide users with prediction data for business volume as accurately as possible.

### SUMMARY

A method and a device for predicting business volume are provided according to the embodiments of the disclosure, to provide a user with prediction data for business volume.

The following technical solutions are provided in the embodiments of the disclosure.

A method for predicting business volume is provided, which includes:

determining a prediction time and a historical time corresponding to the prediction time;

acquiring historical payment data for a business provider;

determining a number of historical payments for the business provider at the historical time on the basis of the historical payment data; and

predicting business volume of the business provider at the prediction time on the basis of the number of historical payments.

A method for predicting business volume is provided, which includes:

determining a prediction time and a historical time corresponding to the prediction time;

acquiring historical payment data for a restaurant;

determining a number of historical payments for the restaurant at the historical time on the basis of the historical payment data; and

predicting business volume of the restaurant at the prediction time on the basis of the number of historical payments.

A device for predicting business volume is provided, which includes: one or more processors and a memory; wherein one or more programs are stored in the memory, and when executed by the one or more processors, the one or more programs cause the one or more processors to:

determine a prediction time and a historical time corresponding to the prediction time;

acquire historical payment data for a business provider;

determine a number of historical payments for the business provider at the historical time on the basis of the historical payment data; and

predict business volume of the business provider at the prediction time on the basis of the number of historical payments.

A device for predicting business volume is provided, which includes:

a time determining module configured determine a prediction time and a historical time corresponding to the prediction time;

a data acquiring module configured to acquire historical payment data for a restaurant;

a number determining module configured to determine a number of historical payments for the restaurant at the historical time on the basis of the historical payment data; and

a predicting module configured to predict business volume of the restaurant at the prediction time on the basis of the number of historical payments.

A computer program product including a computer program stored on a non-volatile computer storage medium is provided. The computer program includes program instructions. The program instructions, when being executed by a computer, enable the computer to execute to the method for predicting business volume.

A non-volatile computer storage medium on which computer instructions are stored is provided. The computer instructions enable the computer to execute the method for predicting business volume.

With the above at least one technical solution according to the embodiment of the present disclosure, the following beneficial effects can be realized. In the embodiment of the present disclosure, future business volume is predicted on the basis of historical business volume data, and a prediction result is corrected on the basis of current business volume data. As compared with the prior art in which only historical data is provided, future data is predicted on the basis of historical data and current data, thereby providing an accurate reference for the user's consumption choice.

### BRIEF DESCRIPTION OF THE DRAWINGS

The drawings described herein, as a part of the disclosure, are used to provide a further understanding for the present disclosure. The exemplary embodiments of the disclosure and illustration thereof are intended to interpret the disclosure rather than improperly limiting the disclosure. In the drawing:

FIG. 1 is a schematic flowchart of a method for predicting business volume according to an embodiment of the present disclosure;

FIG. 2 is a schematic diagram illustrating a historical trend of a payment number according to an embodiment of the present disclosure;

FIG. 3 is a schematic diagram of correcting predicted business volume data according to an embodiment of the present disclosure;

FIG. 4 is a schematic flowchart of a method for predicting business volume in an actual business scenario according to an embodiment of the present disclosure;

FIG. 5 is a schematic structural diagram of a device for predicting business volume according to an embodiment of the present disclosure;

FIG. 6 is a schematic structural diagram of a device for predicting business volume in an actual service scenario according to an embodiment of the present disclosure;

FIG. 7 is a schematic block diagram of a computing device for executing a method for predicting business volume according to an embodiment of the present disclosure; and

FIG. 8 is a schematic diagram showing a storage unit on which program codes for implementing a method for predicting business volume according to an embodiment of the present disclosure are hold and carried.

### DETAILED DESCRIPTION

In order to make the objective, the technical solution and the advantages of the present disclosure clear, the technical solutions of the present disclosure are clearly and completely described below in conjunction with the specific embodiments of the present disclosure and the corresponding drawings. It is apparent that the described embodiments are only a part rather than all of the embodiments of the present disclosure. All other embodiments obtained by those skilled in the art on the basis of the embodiments of the present disclosure without any creative work fall within the protection scope of the present disclosure.

As described above, the user requires information on future business volume of a store. In the embodiment of the present disclosure, future data is predicted on the basis of historical data and current data.

The technical solutions provided by the embodiments of the present disclosure are described in detail below with reference to the accompanying drawings.

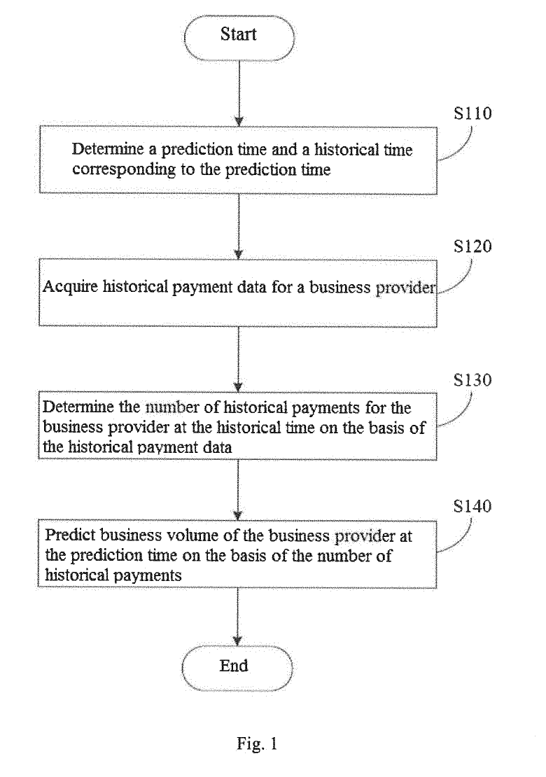

FIG. 1 is a schematic flowchart of a method for predicting business volume according to an embodiment of the present disclosure, which includes the following steps S110 to S140.

In S110, a prediction time and a historical time corresponding to the prediction time are determined.

Specifically, the prediction time here is determined according to the demands of the user, that is, a demand that the user wants to acquire business volume of a business provider (for example, a restaurant) at the prediction time. According to the embodiment of the present disclosure, the prediction time is a future time, and the business volume at the future time cannot be directly acquired by the user, but is wanted by the user. For example, it is now 2:00 pm, and the user wants to acquire the business volume of a restaurant at 6:00 pm. In this example, the prediction time is 6:00 pm of the day.

Specifically, the historical time is a time in a historical time period corresponding to the prediction time. As in the above example, the prediction time is 6:00 pm of the day, and the historical time may be 6:00 pm of the previous day.

The historical time may also be multiple historical time in multiple historical time periods corresponding to the prediction time. For example, the prediction time is 6:00 pm of the day, and the historical time can be 6:00 pm of the previous day, 6:00 pm of the day before the previous day, 6:00 pm of the day before the previous two day, and so on. Regarding multiple historical time, the number of historical payments at each of the multiple historical time in the historical payment data may be calculated according to a preset algorithm, and a calculation result is taken as the number of payments at the historical time, which is described below.

In S120: historical payment data for a business provider is acquired.

Specifically, in a practical application, after the user acquires the goods or services provided by the business provider, it is usually necessary for the user to pay the resource cost (for example, paying money corresponding to the goods or service to the business provider) to the business provider. Therefore, data related to the resource cost paid by the user in history is the historical payment data as described in the above. The business provider includes, but is not limited to, websites, banks, telecom operators, etc. Historical payment data includes, but is not limited to information related to the business volume, such as a payment date, payment time, the payment amount, and the number of payments, which are not limited here.

As a possible way in practical applications, the acquisition of historical payment data can be implemented by the server of the business provider.

In S130, the number of historical payments for the business provider at the historical time is determined on the basis of the historical payment data.

As described above, the historical payment data may include information on the payment time, the number of payments or the like, and then the number of historical payments at a historical time may be determined.

For example, if it is determined that the historical time is 6:00 pm of the previous day, the number of payments at 6:00 pm of the previous day can be determined on the basis of the information on the payment time and the number of payments contained in the historical payment data.

In S140, the business volume of the business provider at the prediction time is predicted on the basis of the number of historical payments.

For example, if the prediction time is 6:00 pm of the day and the historical time is 6:00 pm of the previous day, the business volume at 6:00 pm of the day can be predicted on the basis of the number of payments at 6:00 pm of the previous day.

With the above steps, if the user requires to know business volume of the business provider at a certain future time (that is, the prediction time), the historical time can be determined on the basis of the prediction time, and possible business volume of the business provider at a future time is predicted on the basis of the number of payments for the business provider at the historical time.

As compared with the prior art in which historical payment data at multiple time is provided only, future data can be predicted on the basis of the historical payment data and current data in the present disclosure, thereby providing a more accurate reference for the user's consumption choice.

It should be understood that the present disclosure is not limited to the situation exemplified above. The historical time period may be a time period with various lengths according to needs in the actual application. For example, the historical time period may be one day, one week, one month, one year, and the like in history. In addition, the historical time period may also be a part of one day, one week, one month, one year and other time period, such as a working time period (from 8:00 to 20:00 o'clock) of one day, a working day (from Monday to Friday) of the week, etc. The historical time period may also be a time period across a regular time unit, such as the time period from 8:00 am of the first day to 12:00 am of the next day. It should be understood by those skilled in the art that the example of the historical time period herein is not intended to limit the present disclosure, and other time period for calculating the business volume can also be used.

Therefore, determining the historical time corresponding to the prediction time includes determining each historical time in multiple historical time periods corresponding to the prediction time.

The time in the embodiments of the present disclosure should also be broadly understood on the basis of the specific situations of the time period. For example, if the historical time period is one day, the historical time may be one hour of the day. If the historical time period is one week, the historical time may be one day of the week.

According to the embodiment of the present disclosure, the business volume (such as the number of payments) at certain time may be an accumulated value of business volume before, after or near the time. For example, regarding a time period of one day, the business volume at certain time may be an accumulated value of business volume before, after or near a time point, as long as the business volume at each time covers the entire time period, regarding a time period of one week, the business volume at a certain time can be the accumulated value of the business volume of a day, which is not limited here.

Therefore, in practical applications, information included in the historical payment data may be a relationship between business volume and time (for example, which is represented by the time point) in one day in history, or a relationship between business volume and time (for example, which is represented by the day) in one week in history. In addition, the information included in the historical payment data may also be a variation relationship of business volume during a part time period of the day or a part time period of the week, which is not distinguished and not limited hereinafter.

As described above, the historical time may be one time in the historical time period corresponding to the current time, or may be multiple historical time in multiple historical time periods corresponding to the prediction time.

Regarding one historical time that for example, the historical payment data only includes information on the number of payments in a restaurant in the previous day, the number of payments at the historical moment can be directly acquired.

Regarding multiple historical time, the number of historical payments at each of the multiple historical time in the historical payment data are calculated according to the preset algorithm, and a calculation result is taken as the number of payments at the historical time. Specifically, an operation that the business volume of the business provider at the prediction time is predicted on the basis of the number of historical payments includes: calculating the number of historical payments for the business provider at each of the multiple historical time according to the preset algorithm, and predicting business volume of the business provider at the prediction time on the basis of the calculation result.

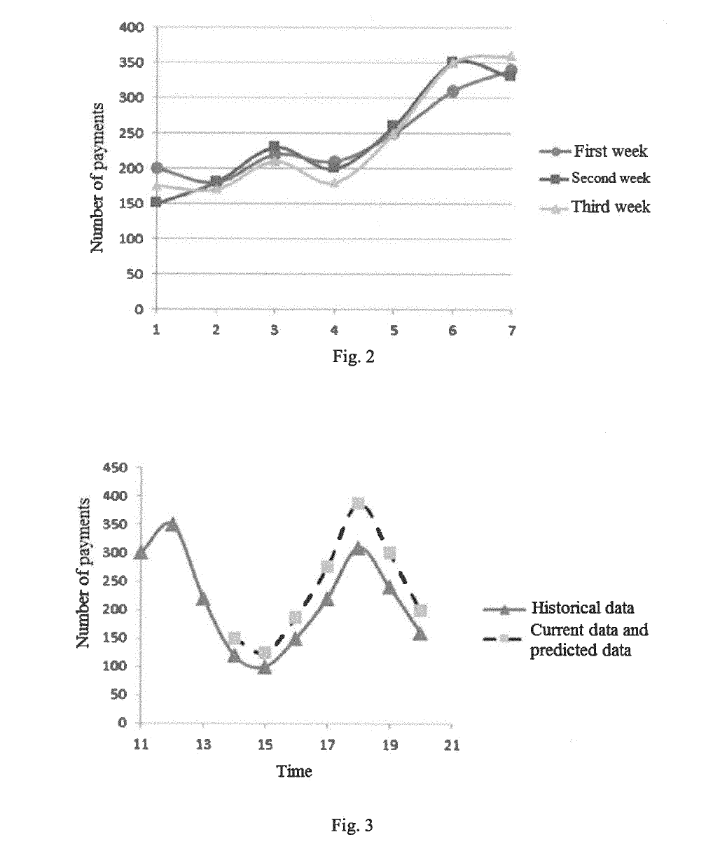

Table 1 below is taken as an example, to provide data on the number of historical payments of a business in three weeks. On the basis of the data in Table 1, a schematic diagram in FIG. 2 can be generated.

TABLE 1
Data on the number of History Payments of a business

| | Monday | Tuesday | Wednesday | Thursday | Friday | Saturday | Sunday |
|---|---|---|---|---|---|---|---|
| First week | 200 | 180 | 220 | 210 | 250 | 310 | 340 |
| Second week | 150 | 180 | 230 | 200 | 260 | 350 | 330 |
| Third week | 175 | 170 | 210 | 180 | 250 | 350 | 360 |

FIG. 2 is a schematic diagram showing a historical trend of the number of payments according to an embodiment of the present disclosure, in which, the abscissa indicates every day of the week, and the ordinate indicates the number of payments in the day. A general trend of business volume of the store per week can be seen from FIG. 2.

Various preset algorithms can be used according to actual needs to generate an overall number of historical payments for each number of historical payments. For example, according to an embodiment of the present disclosure, an arithmetic average value of the number of payments in three weeks may be acquired on the basis of the number of payments per day. With taking Monday as an example, an average value of the number of payments in three weeks is equal to (200+150+175)/3=175. Similarly, an average value of the number of payments per day can be acquired. According to the embodiment of the present disclosure, after multiple historical time corresponding to the prediction time is determined, an average value of each number of historical payments is taken as the number of payments at the historical time.

Those skilled in the art should understand that the number of payments at the historical time can also be acquired in other ways, such as a weighted average method (a high weight is used for the number of payments at a recent historical time, and a low weight is used for the number of payments at an early historical time), the geometric mean method, the median calculation method, etc., and which are not limited here.

According to the embodiment of the present disclosure, after the number of payments at the historical time is acquired, the business volume at the prediction time may be predicted on the basis of the number of payments at the historical time.

For example, the number of payments on Monday in next week in future can be directly predicted to be 175 on the basis of the number of historical average payments of 175 on Monday.

Only one situation is exemplified herein, and is not intended to limit the disclosure. Other methods can be used by those skilled in the art, to predict future business volume on the basis of the number of payments at the historical time.

For example, marketing factors can be taken into account to predict future business volume. It is supposed that the store participates in marketing activities in this week, and the marketing contributes 20% to the business volume on the basis of historical payment data or empirical data. The historical trend may be raised by 20% to predict future business volume. With reference to the above example, business volume on Monday of the next week in future can be predicted to be 175*(1+20%)=210.

For another example, weather factors can be taken into account to predict future business volume. It is supposed that the average temperature in this week drops by 5 degrees Celsius from the average temperature in last week, and such temperature drop contributes −12% to the business volume (that is, which results in decline in future business volume) according to historical payment data or empirical data. The historical trend is lowered by 12% to predict future business volume. With reference to the above example, the business volume on Monday of the next week may be predicted to be 175*(1-12%)=154.

Those skilled in the art can also take other factors or a combination of various factors into account to predict future business volume on the basis of the historical trend of business volume.

In addition, according to the embodiment of the present disclosure, the prediction can be corrected by taking the number of payments at the current time. That is, an operation that the business volume of the business provider at the prediction time is predicted on the basis of the number of historical payments includes: acquiring payment data for the business provider at the current time; determining the number of current payments for the business provider at the current time on the basis of the payment data for the business provider at the current time; determining a reference time corresponding to the current time in the historical time period; determining the number of reference payments for the business provider at the reference time on the basis of the historical payment data for the business provider; and predicting business volume of the business provider at the prediction time on the basis of the number of current payments, the number of reference payments and the number of history payments.

More specifically, the operation that the business volume of the business provider at the prediction time is predicted on the basis of the number of current payments, the number of reference payments and the number of history payments includes: determining a difference between the number of current payments and the number of reference payments; determining a weight corresponding to the difference on the basis of a preset correspondence between the weight and the difference; and predicting business volume of the business provider at the prediction time on the basis of the weight and the number of history payments.

Reference is made to FIG. 3 for illustration. FIG. 3 is a schematic diagram of correcting predicted business volume data according to an embodiment of the present disclosure. The abscissa indicates a time of a day, the ordinate indicates the number of payments at the time, a lower data curve represents historical payment data, and an upper data point represents current data and predicted data.

Specifically, for example, the current time is 14 o'clock (that is, 2:00 pm), and the number of payments at the current time can be acquired by a database of a server of the business provider, which is assumed to be 150. In addition, a reference time corresponding to the current time is determined in the historical time period, which may be 14 o'clock in the historical time period. The number of payments at the reference time is determined to be 120 on the basis of the historical payment data. The difference between the number of payments at the current time and the number of payments at the reference time is determined to be 150−120=30. The weight corresponding to the difference is determined according to the preset correspondence between the differences and the weights. For example, the weight corresponding to the difference is determined to be 30/120=0.25 on the basis of a percentage relationship between the difference and the number of payments at the reference time. Finally, the number of payments at the prediction time (for example, 18 o'clock) can be predicted on the basis of the number of payments at the historical time (for example, 18 o'clock in the historical time period) according to the weight of 0.25. In a case that the number of payments at the historical time is assumed to be 300, the number of payments at the prediction time is predicted to be 300×(1+0.25)=375.

In a similar manner, the number of payments at more prediction time can be predicted, as shown by the dashed line in FIG. 3. Therefore, a future trend is generated for providing a reference for the user. Of course, the above examples are only intended to illustrate a manner of correcting prediction for the business volume, and are not be intended to limit the disclosure.

In addition, according to the embodiment of the present disclosure, the method for predicting business volume in the present disclosure may be on the basis of a geographic location of a user. Specifically, the operation that historical payment data for the business provider is acquired includes: determining a geographic location of the user; determining a business provider within a predetermined range from the geographic location of the user on the basis of the geographic location of the user and a geographical location of each of business providers stored in advance; and acquiring historical payment data for the determined business provider.

In general, it is more desirable for the user to acquire prediction for business volume for stores around the current location. By determining the geographic location of the user and predicting the business volume of the stores near that geographic location, users may be provided with a pertinent prediction result.

The above examples are only used for illustrating the method for predicting business volume described according to the embodiments of the present disclosure, and are not construed as limiting the present disclosure.

In addition to the above scenarios, a restaurant recommendation application (hereinafter referred to as a recommendation application) is widely used by the user. Through the recommendation application, the user can acquire basic information and dining situations of various restaurants. Therefore, the method for predicting business volume according to the embodiment of the present disclosure is also applicable to a scenario in which a dining situation of the restaurant at a future time is predicted.

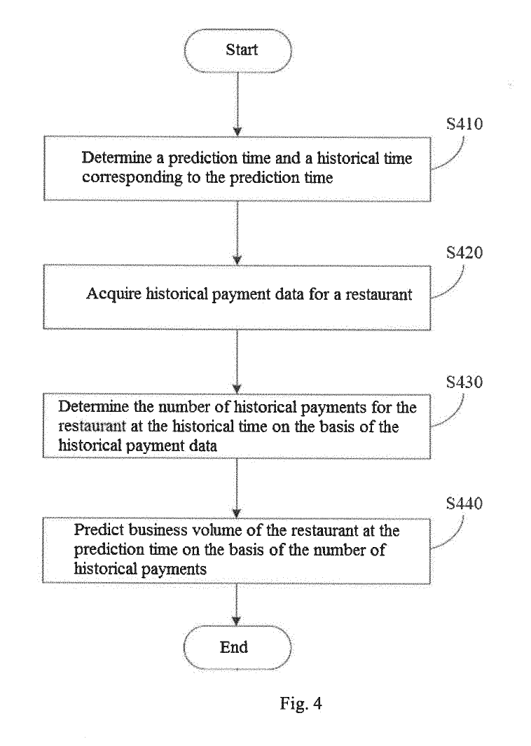

The method for predicting business volume in the scenario is as shown in FIG. 4, and includes the following steps S410 to S440.

In S410, a prediction time and a historical time corresponding to the prediction time are determined.

In S420, historical payment data for the restaurant is acquired.

In S430, the number of historical payments for the restaurant at the historical time is determined on the basis of the historical payment data.

In S440, business volume of the restaurant at the prediction time is predicted on the basis of the number of historical payments.

In this scenario, the operation that the historical time corresponding to the prediction time is determined includes: determining multiple historical time in multiple historical time periods corresponding to the prediction time. The operation that the business volume of the restaurant at the prediction time is predicted on the basis of the number of historical payments includes: calculating the number of historical payments for the restaurant at each of multiple historical time according to the preset algorithm, and predicting business volume of the restaurant at the prediction time on the basis of a calculation result.

The operation that the business volume of the restaurant at the prediction time is predicted on the basis of the number of historical payments includes: acquiring payment data for the restaurant at the current time; determining the number of current payments for the restaurant at the current time on the basis of the payment data for the restaurant at the current time; and determining a reference time in the historical time period corresponding to the current time; determining the number of reference payments for the restaurant at the reference time on the basis of the historical payment data for the restaurant; and predicting business volume of the restaurant at the prediction time on the basis of the number of current payments, the number of reference payments and the number of historical payments.

The operation that the business volume of the restaurant at the prediction time is predicted on the basis of the number of current payments, the number of reference payments and the number of historical payments includes: determining a difference between the number of current payments and the number of reference payments; determining a weight corresponding to the difference on the basis of a preset correspondence between weights and differences; and predicting business volume of the restaurant at the prediction time on the basis of the weight and the number of historical payments.

The operation that historical payment data for the restaurant is acquired includes: determining a geographic location of the user; determining a restaurant within a predetermined range from the geographic location of the user on the basis of the geographic location of the user and a geographical location of each of restaurants stored in advance; and acquiring historical payment data for the determined restaurant.

For example, the user may determine a current location of the user by using a positioning function in the recommendation application. It is assumed that a restaurant exists within a set range from the current location of the user, and a dining situation of the restaurant at a prediction time of 6:00 pm of the day is predicted by the user on the basis of user's requirement. Therefore, the historical time can be 6:00 pm of the previous day. Historical payment data including the payment situation of the restaurant is acquired. The number of payments of the restaurant at 6:00 pm of the previous day is determined to be, for example, 300 on the basis of the historical payment data, and business volume of the restaurant at 6:00 pm of the day is predicted on the basis of the number of payments of 300 of the restaurant at 6:00 pm of the previous day. It is assumed that the current time is 2:00 pm, the number of current payments is 150. Reference time is determined to be 2:00 pm of the previous day in the historical time period, and the number of payments at the reference time is determined to be 120 on the basis of the historical payment data. A difference between the number of payments at the current time and the number of payments at the reference time is 150−120=30. For example, according to the percentage relationship between the difference and the number of payments at the reference time, a weight corresponding to the difference is determined to be 30/120=0.25. Finally, the number of payments at the prediction time can be predicted on the basis of the weight of 0.25 and the number of payments at the historical time, that is, the number of payments at the prediction time is predicted to be 300×(1+0.25)=375 on the basis of the number of payments of 300 at the historical time.

In the actual application scenario for the restaurant, a popularity value of the restaurant at the prediction time may be determined on the basis of the predicted business volume of the restaurant at the prediction time and the preset rule, and the popularity value is displayed. The popularity value can also be displayed in a star-rated manner. For example, if the business volume exceeds a preset value, the popularity value is displayed as five stars. The above manner is not intended to limit the embodiment of the present disclosure.

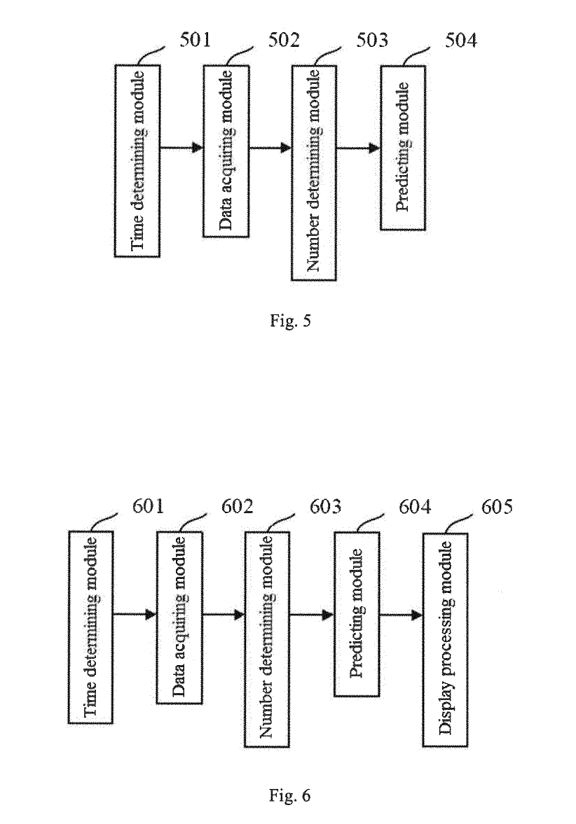

The method for predicting the business volume according to the embodiment of the present disclosure is described above. On the basis of the same idea, a device for predicting business volume is further provided in the application, as shown in FIG. 5

FIG. 5 is a schematic structural diagram of a device for predicting business volume according to an embodiment of the present disclosure. The device for predicting business volume includes a time determining module 501, a data acquiring module 502, a number determining module 503 and a predicting module 504.

The time determining module 501 is configured to determine a prediction time and a historical time corresponding to the prediction time.

The data acquiring module 502 is configured to acquire historical payment data for a business provider.

The number determining module 503 is configured to determine the number of historical payments for the business provider at the historical time on the basis of the historical payment data.

The predicting module 504 is configured to predict business volume of the business provider at the prediction time on the basis of the number of historical payments.

The time determining module 501 is configured to determine multiple historical time in multiple historical time periods corresponding to the prediction time.

The predicting module 504 is configured to calculate the number of historical payments for the business provider at each of the plurality of historical time according to a preset algorithm, and predicting business volume of the business provider at the prediction time on the basis of a calculation result.

The predicting module 504 is configured to acquire payment data for the business provider at a current time, determine the number of current payments for the business provider at the current time on the basis of the payment data for the business provider at the current time, determine a reference time corresponding to the current time in the historical time period, determine the number of reference payments for the business provider at the reference time on the basis of the historical payment data for the business provider, and predict business volume of the business provider at the prediction time on the basis of the number of current payments, the number of reference payments and the number of historical payments.

The predicting module 504 is configured to determine a difference between the number of current payments and the number of reference payments, determine a weight corresponding to the difference on the basis of a preset correspondence between weights and differences, and predict business volume of the business provider at the prediction time on the basis of the weight and the number of historical payments.

The data acquiring module 502 is configured determine a geographic location of the user; determine a business provider within a predetermined range from the geographic location of the user on the basis of the geographic location of the user and a geographical location of each of business providers stored in advance; and acquire historical payment data for the determined business provider.

For an application scenario of a restaurant for providing on-site dining service, a device for predicting a business volume is provided in the present disclosure. As shown in FIG. 6, the device includes a time determining module 601, a data acquiring module 602, a number determining module 603 and a predicting module 604.

The time determining module 601 is configured to determine a prediction time and a historical time corresponding to the prediction time.

The data acquiring module 602 is configured to acquire historical payment data for a restaurant.

The number determining module 603 is configured to determine the number of historical payments for the restaurant at the historical time on the basis of the historical payment data.

The predicting module 604 is configured to predict business volume of the restaurant at the prediction time on the basis of the number of historical payments.

Furthermore, the time determining module 601 is configured to determine multiple historical time in multiple historical time periods corresponding to the prediction time.

The predicting module 604 is configured to calculate the number of historical payments for the restaurant at each of a plurality of historical time according to the preset algorithm, and predicting the business volume of the restaurant at the prediction time on the basis of a calculation result.

The predicting module 604 is configured to acquire payment data for the restaurant at a current time; determine the number of current payment for the restaurant at the current time on the basis of the payment data for the restaurant at the current time; determine a reference time in the historical time period corresponding to the current time; determine a number of reference payments for the restaurant at the reference time on the basis of the historical payment data for the restaurant; and predict the business volume of the restaurant at the prediction time on the basis of the number of current payments, the number of reference payments and the number of historical payments.

The predicting module 604 is configured to determine a difference between the number of current payments and the number of reference payments; determine a weight corresponding to the difference on the basis of a preset correspondence between weights and differences; and predict business volume of the restaurant at the prediction time on the basis of the weight and the number of historical payments.

The data acquiring module 602 is configured determine a geographic location of the user; determine a restaurant within a predetermined range from the geographic location of the user on the basis of the geographic location of the user and a geographical location of each of restaurants stored in advance; and acquire historical payment data for the determined restaurant.

The device further includes a display processing module, which is configured to determine a popularity value of the restaurant at the prediction time on the basis of the predicted business volume of the restaurant at the prediction time and a preset rule, and display the popularity value.

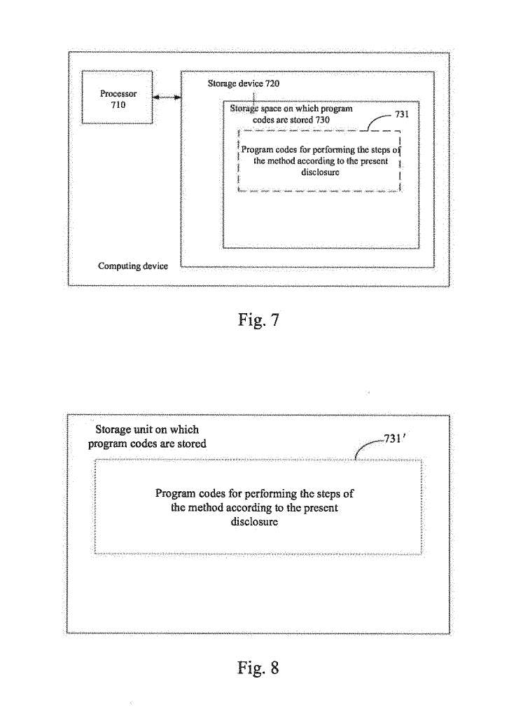

A computing device for implementing the method for predicting business volume according to the present disclosure is further provided according to the present disclosure. As shown in FIG. 7, the computing device conventionally includes a processor 710 and a computer program product or a computer readable medium in the form of a storage device 720. The storage device 720 can be an electronic memory such as flash memory, an electrically erasable programmable read only memory (EEPROM), an EPROM, a hard disk or an ROM. The storage device 720 has a storage space 730 on which program codes 731 for performing any of the steps of the method described above are stored. For example, the storage space 730 on which the program codes are stored may include program codes 731, each of which is used for implementing each of steps in the above method, respectively. The program codes can be read from or written into one or more computer program products. These computer program products include program code carriers such as a hard disk, a compact disk (CD), a memory card, or a floppy disk. Such a computer program product is typically for example a portable or fixed storage unit as shown in FIG. 8. The storage unit may have storage segments, storage spaces, and the like as arrangement in storage device 720 in the computing device shown in FIG. 7. The program code can be compressed, for example, in an appropriate form. Typically, the storage unit includes computer readable codes 731′ for performing the steps of the method according to the present disclosure, that is, codes that can be read by a processor such as 710. The codes, when being executed by the computing device, enable the computing device to perform the steps in the method described above.

In addition, in the 1990s, an improvement to a technology could be clearly distinguished between a hardware improvement (for example, an improvement to a circuit structure such as diodes, transistors, switches) and a software improvement (an improvement to a method flow). However, with development of technology, the improvement to a method flow can be regarded as a direct improvement to a hardware circuit structure currently. Designers almost get a hardware circuit structure by programming the improved method flow into the hardware circuit. Therefore, it is possible that the improvement to a method flow can be implemented by hardware entity modules. For example, a programmable logic device (PLD) (for example, a field programmable gate array (FPGA)) is such an integrated circuit, a logic function of which is determined in a case that the user programs the device. A digital system is integrated into a single PLD in a case that the user programs without asking the chip manufacturer to design and fabricate a dedicated integrated circuit chip. Moreover, today, instead of manually making integrated circuit chips, such programming is mostly implemented using “logic compiler” software, which is similar to the software compiler used in programming development. Before compiling, original codes are written in a specific programming language, which is called as Hardware Description Language (HDL). The HDL includes multiple languages such as Advanced Boolean Expression Language (ABEL). Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc. The Very-High-Speed Integrated Circuit Hardware Description Language (VHDL) and the Verilog are used commonly currently. It should also be apparent to those skilled in the art that the method flow is programmed logically into an integrated circuit using the above hardware description language, to easily implement a hardware circuit for implementing the logical method flow.

Moreover, the controller can be implemented in any suitable manner. For example, the controller can be in the form of, for example, a microprocessor, a processor and a computer readable medium for storing computer readable program codes (eg, software or firmware) executable by the (micro)processor, a logic gate, a switch, an application specific integrated circuit (ASIC), a programmable logic controller and an embedded microcontroller. The controller includes but is not limited to for example the following microcontrollers: ARC 625D, Atmel AT91SAM, Microchip PIC18F26K20, and Silicone Labs C8051F320. The controller in the form of the memory can also be implemented as a part of control logic of the memory. Those skilled in the art also appreciate that, in addition that the controller is implemented in purely computer readable program code, functions of the controller can also be implemented by means of logic gates, switches, ASICs, programmable logic controllers, and embedded microcontrollers by logically programming the steps of the method. Such controller can therefore be regarded as a hardware component, and devices in the controller for implementing various functions may also be regarded as a structure within the hardware component. Or even a device for implementing various functions can be regarded as a software module for implementing the method and a structure within the hardware component.

The system, device, module or unit illustrated in the above embodiments may be implemented by a computer chip or an entity, or by a product having a function. A typical implementation device is a computer. Specifically, the computer can be, for example, a personal computer, a laptop computer, a cellular phone, a camera phone, a smart phone, a personal digital assistant, a media player, a navigation device, an email device, a gaconsole, a tablet computer, a wearable device, or a combination of any of the above devices.

For the convenience of description, the above device is divided into multiple units according to functions for separately describe the multiple units. Of course, the functions of all of the units may be implemented in the one or more software and/or hardware in implementation of the present disclosure.

Those skilled in the art should appreciate that embodiments of the present disclosure can be embodied as a method, a system, or a computer program product. Thus, the present disclosure may be in the form of an entirely hardware embodiment, an entirely software embodiment, or an embodiment in which software and hardware are combined.

The present disclosure is described with reference to the flowchart and/or block diagrams of methods, devices (system), and computer program products according to embodiments of the present disclosure. It will be understood that each flow and/or block in the flowchart and/or block diagrams, and a combination of the flow and the block in the flowchart and/or block diagrams can be implemented by a computer program instruction. The computer program instruction can be provided to a processor of a general purpose computer, a special purpose computer, an embedded processor, or other programmable data processing device to produce a machine, so that the instruction executed by the processor of the computer or other programmable data processing device enables a device for implementing the function specified in one or more flows of the flowchart or one or more blocks of the block diagram.

The computer program instruction may also be stored in a computer readable memory which can direct the computer or other programmable data processing device to operate in a particular manner, and the instruction stored in the computer readable memory enables an article of manufacture comprising the instruction device. The instruction device implements the function specified in one or more flows of the flowchart or one or more blocks of the block diagram.

The computer program instruction can also be loaded onto a computer or other programmable data processing device, and a series of operation steps are performed on the computer or other programmable device to produce processing implemented by the computer. Therefore, the instruction executed on the computer or other programmable device provides steps for implementing the function specified in one or more flows of the flowchart or one or more blocks of the block diagram.

It should also be illustrated that the terms “comprise” or “include” or any other variations thereof are intended to encompass a non-exclusive inclusion, such that a process, a method, an article or a device including a series of factors also includes other factors not explicitly listed in addition to the series of factors, or includes elements that are inherent to such the process, the method, the article or the device. Without more limitation, a factor defined by the phrase “including a . . . ” does not exclude the presence of additional equivalent factors in the process, the method, the article, or the device including the factors.

Those skilled in the art should understand that the embodiments of the present disclosure can be embodied as a method, a system, or a computer program product. Thus, the present disclosure may be in the form of an entirely hardware embodiment, an entirely software embodiment or an embodiment in which software and hardware are combined.

The foregoing is only an embodiment of the present disclosure and is not intended to limit the disclosure. Various changes and modifications can be made to the present disclosure by those skilled in the art. Any modifications, equivalent substitutions, improvements or the like made within the spirit and scope of the present disclosure fall within the scope of the claims of the present disclosure.

What is claimed is:

1. A method for predicting business volume, comprising:
determining a prediction time and a historical time corresponding to the prediction time;
acquiring historical payment data for a business provider;
determining a number of historical payments for the business provider at the historical time on the basis of the historical payment data; and
predicting business volume of the business provider at the prediction time on the basis of the number of historical payments.

2. The method according to claim 1, wherein the determining the historical time corresponding to the prediction time comprises:
determining a plurality of historical time in a plurality of historical time periods corresponding to the prediction time, and
the predicting the business volume of the business provider at the prediction time on the basis of the number of historical payments comprises:
calculating the number of historical payments for the business provider at each of the plurality of historical time according to a preset algorithm, and predicting business volume of the business provider at the prediction time on the basis of a calculation result.

3. The method according to claim 1, wherein the predicting business volume of the business provider at the prediction time on the basis of the number of historical payments comprises:
acquiring payment data for the business provider at a current time;
determining a number of current payments for the business provider at the current time on the basis of the payment data for the business provider at the current time;
determining a reference time in the historical time period corresponding to the current time;
determining a number of reference payments for the business provider at the reference time on the basis of the historical payment data for the business provider; and
predicting business volume of the business provider at the prediction time on the basis of the number of current payments, the number of reference payments and the number of historical payments.

4. The method according to claim 3, wherein the predicting business volume of the business provider at the prediction time on the basis of the number of current payments, the number of reference payments and the number of historical payments comprises:
determining a difference between the number of current payments and the number of reference payments;
determining a weight corresponding to the difference on the basis of a preset correspondence between weights and differences; and
predicting business volume of the business provider at the prediction time on the basis of the weight and the number of historical payments.

5. The method according to claim 1, wherein the acquiring historical payment data for the business provider comprises:
determining a geographic location of the user;
determining a business provider within a predetermined range from the geographic location of the user on the basis of the geographic location of the user and a geographical location of each of business providers stored in advance; and
acquiring historical payment data for the determined business provider.

6. A method for predicting business volume, comprising:
determining a prediction time and a historical time corresponding to the prediction time;
acquiring historical payment data for a restaurant;
determining a number of historical payments for the restaurant at the historical time on the basis of the historical payment data; and
predicting business volume of the restaurant at the prediction time on the basis of the number of historical payments.

7. The method according to claim 6, wherein the determining the prediction time and the historical time corresponding to the prediction time comprises:
determining a plurality of historical time in a plurality of historical time periods corresponding to the prediction time,
wherein the predicting business volume of the restaurant at the prediction time on the basis of the number of historical payments comprises:
calculating the number of historical payments for the restaurant at each of a plurality of historical time according to the preset algorithm, and predicting the business volume of the restaurant at the prediction time on the basis of a calculation result.

8. The method according to claim 6, wherein the predicting business volume of the restaurant at the prediction time on the basis of the number of historical payments comprises:
acquiring payment data for the restaurant at a current time;
determining a number of current payment for the restaurant at the current time on the basis of the payment data for the restaurant at the current time;
determining a reference time in the historical time period corresponding to the current time;
determining a number of reference payments for the restaurant at the reference time on the basis of the historical payment data for the restaurant; and
predicting the business volume of the restaurant at the prediction time on the basis of the number of current payments, the number of reference payments and the number of historical payments.

9. The method according to claim 8, wherein the predicting the business volume of the restaurant at the prediction time on the basis of the number of current payments, the number of reference payments and the number of historical payments comprises:
determining a difference between the number of current payments and the number of reference payments;
determining a weight corresponding to the difference on the basis of a preset correspondence between weights and differences; and
predicting business volume of the restaurant at the prediction time on the basis of the weight and the number of historical payments.

10. The method according to claim 6, wherein the acquiring historical payment data for the restaurant comprises:
determining a geographic location of the user;
determining a restaurant within a predetermined range from the geographic location of the user on the basis of the geographic location of the user and a geographical location of each of restaurants stored in advance; and
acquiring historical payment data for the determined restaurant.

11. The method according to claim 6, further comprising:
determining a popularity value of the restaurant at the prediction time on the basis of the predicted business volume of the restaurant at the prediction time and a preset rule; and
displaying the popularity value.

12. A device for predicting business volume, comprising:
one or more processors; and
a memory;
wherein one or more programs are stored in the memory, and when executed by the one or more processors, the one or more programs cause the one or more processors to:
determine a prediction time and a historical time corresponding to the prediction time;
acquire historical payment data for a business provider;
determine a number of historical payments for the business provider at the historical time on the basis of the historical payment data; and
predict business volume of the business provider at the prediction time on the basis of the number of historical payments.

13. The device according to claim 12, wherein the one or more processors are further caused to:
determine a plurality of historical time in a plurality of historical time periods corresponding to the prediction time, and
calculate the number of historical payments for the business provider at each of the plurality of historical time according to a preset algorithm, and predicting business volume of the business provider at the prediction time on the basis of a calculation result.

14. The device according to claim 12, wherein the one or more processors are further caused to:
acquire payment data for the business provider at a current time;
determine a number of current payments for the business provider at the current time on the basis of the payment data for the business provider at the current time;
determine a reference time in the historical time period corresponding to the current time;
determine a number of reference payments for the business provider at the reference time on the basis of the historical payment data for the business provider; and
predict business volume of the business provider at the prediction time on the basis of the number of current payments, the number of reference payments and the number of historical payments.

15. The device according to claim 14, wherein the one or more processors are further caused to:
determine a difference between the number of current payments and the number of reference payments;
determine a weight corresponding to the difference on the basis of a preset correspondence between weights and differences; and
predict business volume of the business provider at the prediction time on the basis of the weight and the number of historical payments.

16. The device according to claim 12, wherein the one or more processors are further caused to:
determine a geographic location of the user;
determine a business provider within a predetermined range from the geographic location of the user on the basis of the geographic location of the user and a geographical location of each of business providers stored in advance; and
acquiring historical payment data for the determined business provider.

17. (canceled)

18. (canceled)

19. (canceled)

20. (canceled)

21. (canceled)

22. (canceled)

23. (canceled)

24. (canceled)

25. (canceled)

26. (canceled)
